(19) United States
(12) Patent Application Publication
(10) Pub. No.: US 2007/0000310 A1
(43) Pub. Date: Jan. 4, 2007

(54) Leak detection system with wireless remote unit

(75) Inventors: Stephen J. Yamartino, Wayland, MA (US); Daniel Geist, Boxborough, MA (US); Joseph Klebanov, Brookline, MA (US)

Correspondence Address: Varian Inc.;Legal Department, 3120 Hansen Way D-102, Palo Alto, CA, 94304, US

(73) Assignee: Varian, Inc.

(21) Appl. No.: 11/170,122

(22) Filed: Jun. 29, 2005

(51) Int. Cl. G01M 3/04

(52) U.S. Cl. 73/40.7

(57) ABSTRACT

A leak detection system includes a trace gas leak detector having a wireless base unit, and a handheld wireless remote unit to generate an alphanumeric display of leak rate measured by the leak detector, in response to leak detector information received by wireless link from the leak detector. The remote unit may include a wireless transceiver to communicate with the wireless base unit of the leak detector, a display unit and a controller, responsive to the received leak detector information, to generate the display on the display unit. The remote unit may be configured to control the leak detector and may be configured to display a leak detector operating mode.

### FIELD OF THE INVENTION

This invention relates to trace gas leak detection systems and, more particularly, to leak detection systems and methods which utilize a handheld wireless remote unit to display leak detector operating information.

### BACKGROUND OF THE INVENTION

Helium mass spectrometer leak detection is a well-known leak detection technique. Helium is used as a tracer gas which passes through the smallest of leaks in a unit under test. After passing through a leak, a test sample containing helium is drawn into a leak detector and is measured. An important component of the leak detector is a mass spectrometer tube which detects and measures the helium. The input test sample is ionized and mass analyzed by the spectrometer tube in order to separate and measure the helium component. The unit under test may include a sealed chamber that may be large or small. The sealed chamber may be a vacuum vessel that is to be tested for leaks.

In one mode of operation of the trace gas leak detector, the inlet, or test port, of the leak detector is connected to the sealed chamber of the unit under test. The sealed chamber may be evacuated by a vacuum pumping system. Helium is sprayed onto the exterior of the sealed chamber by a test operator. If the unit under test has a leak, the helium is drawn into the sealed chamber of the unit under test and is measured by the leak detector. The amount of helium detected represents a leak rate. It is possible to determine the location of the leak by moving the helium spray over the sealed chamber and determining the location where the measured leak rate is maximum. The leak can then be repaired or other appropriate action can be taken.

In many applications, the unit under test is large and may be irregular in shape. For example, the leak detector may be used to detect leaks in vacuum processing equipment used for fabrication of semiconductor wafers. Examples of such equipment include but are not limited to ion implanters and coating equipment. The processing equipment includes a vacuum vessel that is tested for leaks. In some cases, such equipment is on the order of 20 to 50 feet long and requires opening of various doors and access panels to reach the vacuum vessel being tested. In addition, test equipment and other objects may clutter the area around the unit under test.

The leak detector can be positioned next to the unit under test. However, the location where the helium is being sprayed onto the vacuum vessel may be 20 to 50 feet or more from the leak detector instrument. Thus, the operator is not able to spray helium onto the vacuum vessel at the remote location and, at the same time, observe the leak rate measured by the leak detector.

One prior art approach involves two operators, one to spray helium and the other to observe the leak rate at the leak detector. However, two operators may not readily be available. Further, the process involves coordination by verbal communication to localize a leak and thus involves inconvenience and possible frustration.

Another prior art approach involves the use of a handheld unit that is connected to the leak detector by a cable. The operator can move around the equipment and observe the measured leak rate on the handheld unit. While this arrangement is satisfactory in principle, the cable may be too short to reach a location of interest or may become entangled in components of the unit under test and equipment that surrounds the unit under test. Therefore, the cable-connected display unit only partially alleviates the difficulties in detecting leaks in large syste

Accordingly, there is a need for improved leak detection systems and methods.

### SUMMARY OF THE INVENTION

According to a first aspect of the invention, a leak detection system comprises a trace gas leak detector including a wireless base unit, and a handheld wireless remote unit to generate an alphanumeric display of leak rate measured by the leak detector, in response to leak detector information received by wireless link from the leak detector.

The remote unit may include a wireless transceiver to communicate with the wireless base unit of the leak detector, a display unit and a controller, responsive to the received leak detector information, to generate the display on the display unit. The remote unit may be configured to display a leak detector operating mode.

The remote unit may further include a keypad to control operation of the leak detector by wireless link from the remote unit to the wireless base unit of the leak detector. The keypad may be configured to select an operating mode of the leak detector.

The controller may be configured to generate on the display unit a bar graph display of leak rate and may be configured for operator selection of a linear display or a log display of leak rate.

According to a second aspect of the invention, a wireless remote unit comprises a wireless transceiver configured for wireless communication with a base unit of a trace gas leak detector, a display unit, and a controller, responsive to leak detector information received by wireless link from the leak detector, to generate on the display unit an alphanumeric display of leak rate measured by the leak detector.

According to a third aspect of the invention, a method is provided for operating a trace gas leak detector. The method comprises measuring a leak rate of a unit under test with a trace gas leak detector, transmitting information representing the measured leak rate to a wireless remote unit, and providing an alphanumeric display of the measured leak rate on the wireless remote unit.

### BRIEF DESCRIPTION OF THE DRAWINGS

For a better understanding of the present invention, reference is made to the accompanying drawings, which are incorporated herein by reference and in which:

FIG. 1 is a schematic block diagram of a leak detection system in accordance with an embodiment of the invention;

FIG. 2 is a flow chart that illustrates operation of the leak detection system in accordance with an embodiment of the invention;

FIG. 3 illustrates an embodiment of a handheld wireless remote unit in accordance with an embodiment of the invention;

FIG. 4A is a schematic block diagram of a leak detector in accordance with an embodiment of the invention;

FIG. 4B is a schematic block diagram of a remote unit in accordance with an embodiment of the invention;

FIG. 5 is a flow chart that illustrates operation of the wireless remote unit in accordance with an embodiment of the invention;

FIGS. 6A-6H illustrate operating displays on the wireless remote unit in accordance with embodiments of the invention; and

FIG. 7 illustrates a setup display on the wireless remote unit in accordance with an embodiment of the invention.

### DETAILED DESCRIPTION OF THE INVENTION

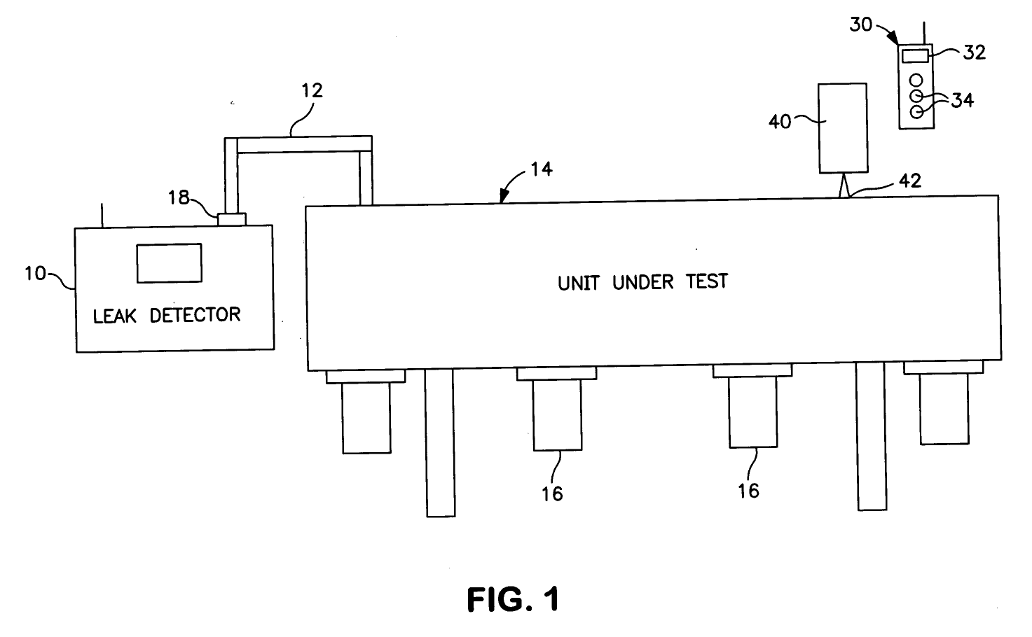

A schematic block diagram of a leak detection system in accordance with an embodiment of the invention is shown in FIG. 1. A leak detector 10 is connected by a vacuum connection 12 to a unit under test 14. Unit under test 14 may be any equipment having a sealed chamber or vessel that requires leak testing. In a non-limiting example, the leak detection system may be used to detect leaks in the vacuum vessel of processing equipment used in the fabrication of semiconductor wafers. The unit under test 14 may include one or more vacuum pumps 16 for evacuating the unit under test 14. The invention is most useful for testing a large unit under test but can be utilized for leak detection in a sealed chamber of any size.

Leak detector 10 is a trace gas leak detection instrument that detects leaks by sensing a trace gas, such as helium, that passes through a leak in a sealed chamber. Leak detector 10 has a display of leak rate and may include various controls, depending on its configuration. By way of example, vacuum connection 12 may be connected between a test port 18 of leak detector 10 and a sealed chamber of unit under test 14. The leak detector may be connected to various vacuum locations. In a typical application, leak detector 10 may be mounted on a cart with wheels and can be moved from location to location. Thus, leak detector 10 may be portable but is not a handheld instrument.

The leak detection system further includes a wireless remote unit 30 that communicates with leak detector 10 by wireless communication link. As described below, leak detector 10 may be provided with a wireless base unit for communication with wireless remote unit 30. Wireless remote unit 30 includes a display unit 32 to display leak detector information, such as measured leak rate, and may include a keypad 34 or a touch screen. Wireless remote unit 30 is described in detail below.

The leak detection system may further include a trace gas source, such as a helium spray 40. Helium spray 40 may be utilized to direct helium gas at an area of interest 42 on unit under test 14. The area of interest 42 may be an area of a suspected leak. Helium spray 40 may include a container to hold helium and a valve to release helium from the container at a controlled rate.

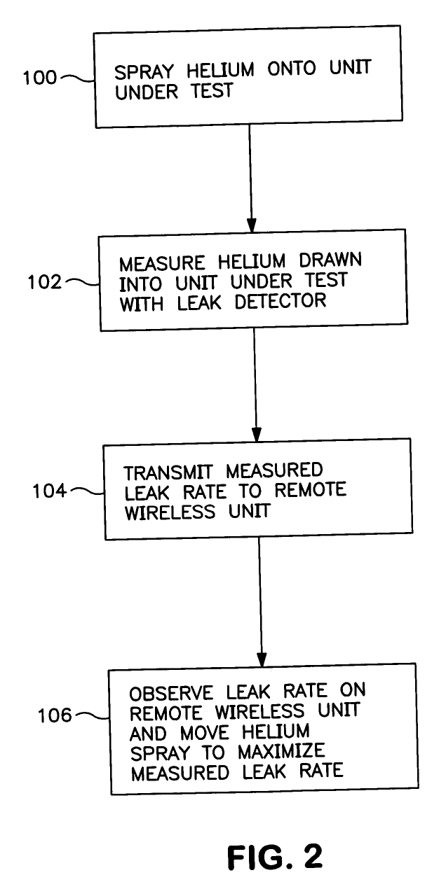

Operation of the leak detection system of FIG. 1 is described with reference to the flow chart of FIG. 2. Initially, the leak detector 10 is connected to the vacuum vessel of the unit under test 14 by vacuum connection 12, and the vacuum vessel is vacuum pumped by vacuum pumps 16. Leak detector 10 typically includes one or more vacuum pumps which establish a desired pressure level at test port 18 of leak detector 10. An operator determines that leak detector 10 is operating correctly and then moves to the unit under test carrying wireless remote unit 30 and helium spray 40.

In step 100, helium is sprayed onto the unit under test 14 at the area of interest 42. Area of interest 42 may be an area of the vacuum vessel of unit under test 14 that is suspected of having a leak and may be remote from leak detector 10. Further, the operator may be required to open and/or remove doors or access panels to reach area of interest 42. The helium sprayed onto unit under test 14 is drawn into the vacuum vessel by the pressure differential between atmosphere and the reduced pressure level in the vacuum vessel.

In step 102, the helium drawn into the vacuum vessel passes through test port 18 and is measured by leak detector 10. The amount of helium measured is a function of the leak rate and thus indicates the presence of a leak and the relative size of the leak.

In step 104, the measured leak rate is transmitted by wireless link from leak detector 10 to wireless remote unit 30. The measured leak rate is displayed on display unit 32 of wireless remote unit 30.

In step 106, the measured leak rate is observed by the operator on the wireless remote unit 30, thereby informing the operator if a leak is present at the area of interest 42. The leak can be localized by moving helium spray 40 and observing a change in the measured leak rate on wireless remote unit 30. The measured leak rate is maximum when helium spray 40 is closest to the leak in the vacuum vessel. Thus, the leak can be localized. Conversely, if the measured leak rate is below a threshold level, no leak is indicated and the operator can move to a new area of interest and continue with leak testing.

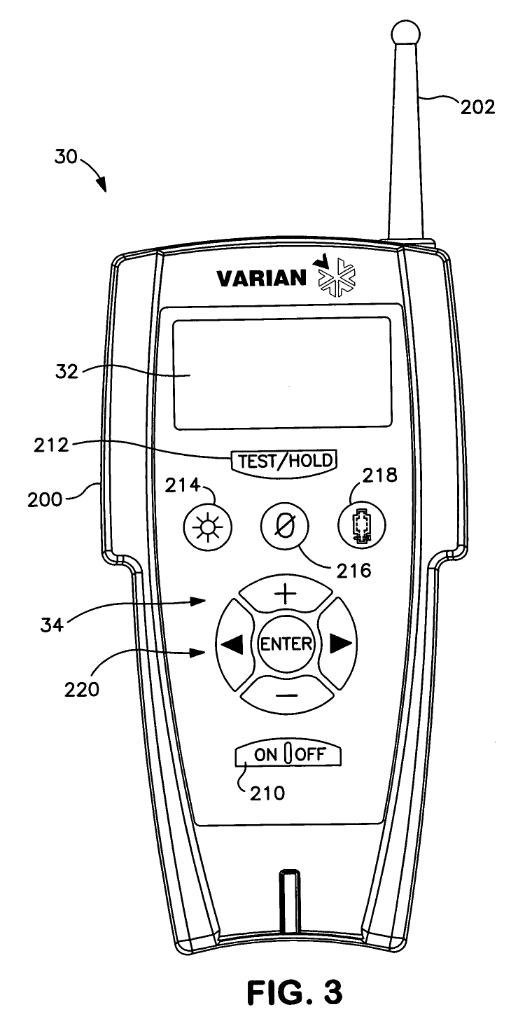

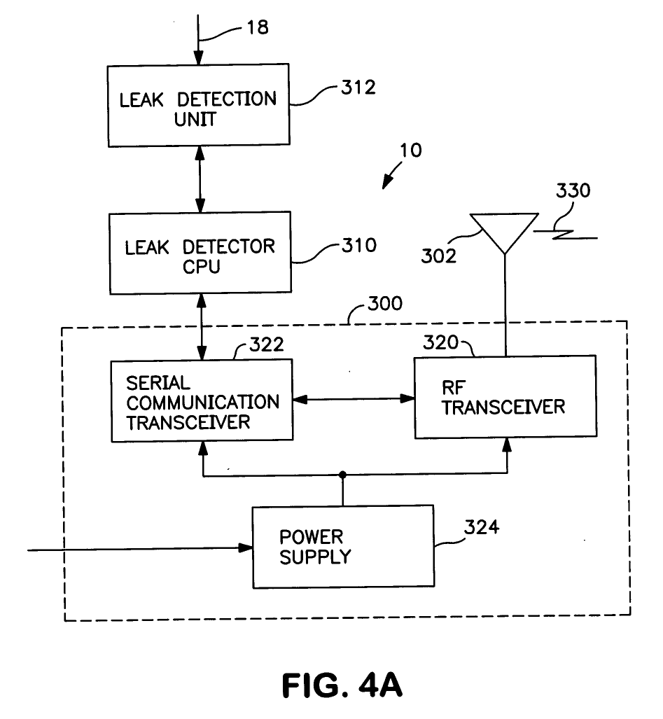

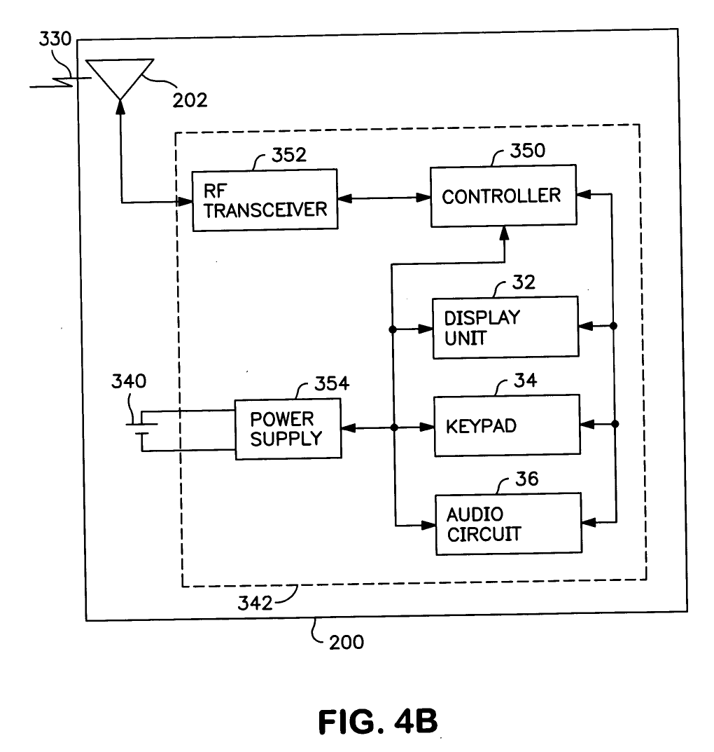

An example of wireless remote unit 30 in accordance with an embodiment of the invention is shown in FIG. 3. Display unit 32 and keypad 34 are mounted in a housing 200 which is configured for handheld operation. An antenna 202 permits wireless communication with a wireless base unit in leak detector 10. Wireless remote unit 30 may further include an audio circuit 36 (FIG. 4B) to provide an audio indication of leak rate. As discussed below, remote unit 30 may further include an RF transceiver, a controller and a battery (not shown in FIG. 3).

Display unit 32 may be a liquid crystal display (LCD) or any other display of suitable size and power consumption for a handheld unit. Display unit 32 is utilized to display leak detector information received from leak detector 10 and to display information relating to the operation and setup of wireless remote unit 30. For example, display unit 32 may display the leak rate measured by leak detector 10.

Keypad 34 may utilize any desired arrangement of key switches. In some embodiments, keypad 34 is utilized for controlling operation of leak detector 10, thus providing wireless remote control of leak detector 10. In other embodiments, wireless remote unit 30 is not utilized for controlling the operation of leak detector 10, but is utilized as a display device to permit remote monitoring of leak detector information, such as leak rate. Keypad 34 can also be utilized for controlling the operation of wireless remote unit 30, such as power on/power off, setup functions and controlling display backlighting. Keypad 34 may be implemented with hardware switches, soft keys, or a combination thereof as known in the art.

As noted above, wireless remote unit 30 is preferably configured for handheld operation. Thus, the size and weight of wireless remote unit 30 are such that an operator can hold the unit in one hand and perform leak detection operations. In one example, housing 200 has a length of about 7.73 inches, a width of about 3.73 inches and a thickness of about 1.84 inches. In this embodiment, wireless remote unit 30 has a weight of about one pound. It will be understood that these values are given by way of example only and are not limiting as to the scope of the present invention.

In the embodiment of FIG. 3, keypad 34 includes an on/off key 210 which is used to power the unit on or off. A test/hold key 212 places the leak detector into test mode or hold mode. The test mode is the normal operating mode for performing a leak test. The hold mode is a standby mode in which a test is not being performed, but the test port is not vented. A backlight key 214 turns a display backlight on and off. The display backlight may automatically be turned off after a prescribed time interval in order to save battery power. A zero key 216 zeroes the leak rate signal at the leak detector. A standard leak key 218 turns on and off a calibrated helium leak that is internal to the leak detector. A user may enable the standard leak from the wireless remote unit to verify that the leak detector is calibrated and operating properly. A cluster of five setup keys 220 allows the user to configure the wireless remote unit 30. Configuration settings may include but are not limited to speaker volume control, display backlight brightness, radio setup functions, display screen contrast adjustment and time before automatic shutoff.

As shown in FIG. 4A, leak detector 10 includes a wireless base station 300, an antenna 302, a leak detector CPU 310 and a leak detection unit 312. Leak detection unit 312 may include a mass spectrometer, one or more vacuum pumps, valves and vacuum conduits as known to those skilled in the art. Leak detection unit 312 receives a test sample containing a trace gas through test port 18, measures the trace gas and supplies a digital value of the measured leak rate to leak detector CPU 310.

Wireless base unit 300 may include a radio frequency (RF) transceiver 320, a serial communication transceiver 322 and a power supply 324. Wireless base unit 300 communicates with remote unit 30 via antenna 302 and a wireless link 330. Wireless base unit 300 also communicates with leak detector CPU 310 via serial communication transceiver 322 using a serial communication protocol. Leak detector CPU 310 controls operation of leak detector 10 and in particular controls operation of leak detection unit 312 to measure the leak rate of a unit under test. Leak detector CPU 310 controls transmission of leak detector information to remote unit 30 and responds to signals received from remote unit 30.

As shown in FIG. 4B, remote unit 30 includes an antenna 202, a battery 340 and a printed circuit board 342 mounted in housing 200. Printed circuit board 342 provides mounting and interconnection of the circuitry for remote unit 30. A controller 350, an RF transceiver 352, a power supply 354, display unit 32, keypad 34 and audio circuit 36 may be mounted on printed circuit board 342. RF transceiver 352 receives data and control signals from controller 350 and communicates with leak detector 10 via antenna 202 and wireless link 330. Controller 350 controls operation of remote unit 30, including receiving and processing information from leak detector 10, generating displays on display unit 32, generating audio signals, responding to keypad entries by the operator and transmitting signals to leak detector 10. By way of example only, controller 350 may be a Model MC9512E family microcontroller manufactured by Freescale Semiconductor, Inc. (Austin, Tex.). Power supply 354 converts the voltage from battery 340 to appropriate voltages and currents for operation of the components of remote unit 30. Audio circuit 36 may include an audio amplifier and a speaker mounted on printed circuit board 342. An audio headset connector may be mounted to housing 200.

The radio circuitry for communication between leak detector and remote unit 30, including RF transceivers 320 and 352 and antennas 302 and 202, may provide a 2.4 GHz wireless serial communication link using a frequency hopping, direct FM, spread spectrum (FHSS) technology. This type of wireless link provides a reliable radio link up to 400 feet in harsh indoor industrial environments using an RS-232 serial data communication protocol. Communication includes leak detection system information and RF configuration data. The 2.4000-2.4835 GHz license-free spectrum band for industrial, scientific and medical operation may be utilized for straightforward, worldwide implementation. In one example, the RF transceivers 320 and 352 utilize a part no. AC4424-100 manufactured by Aerocomm, Inc. (Lenexa, Kans.). It will be understood that this RF configuration is described by way of example only and is not limiting as to the scope of the present invention. In particular, different frequency bands, different modulation techniques and different communication protocols may be utilized within the scope of the present invention.

The radio circuitry may be provided with multiple channels for operation in a facility that has two or more leak detectors and two or more remote units. Using this arrangement, different remote units can communicate with different leak detectors without interference. The system may be configured such that a remote unit establishes communication with a single leak detector, and other remote units are inhibited from communicating with the same leak detector as long as the connection remains in place. However, other remote units can communicate with different leak detectors at the same time. In a smaller facility having a single leak detector and a single remote unit, a single RF channel may be utilized.

The remote unit 30 may provide an audio indication of leak rate for applications where it is inconvenient for the operator to view display unit 32. Controller 350 generates audio frequency signals which are supplied to audio circuit 36. The audio signals may be supplied to a speaker or to a headset worn by the operator. The audio signal, which may be in a range of 200 to 6000 Hz, may be proportional to leak rate and may be pulsed on and off at a specified rate. The pulse rate and the tone frequency may indicate leak rate. It will be recognized that the audio signal does not provide a numerical value of leak rate but instead indicates a range of leak rates and may indicate whether the leak rate is increasing or decreasing. This function may be useful in the case where the operator is moving the helium spray over an area of interest and is attempting to localize a leak.

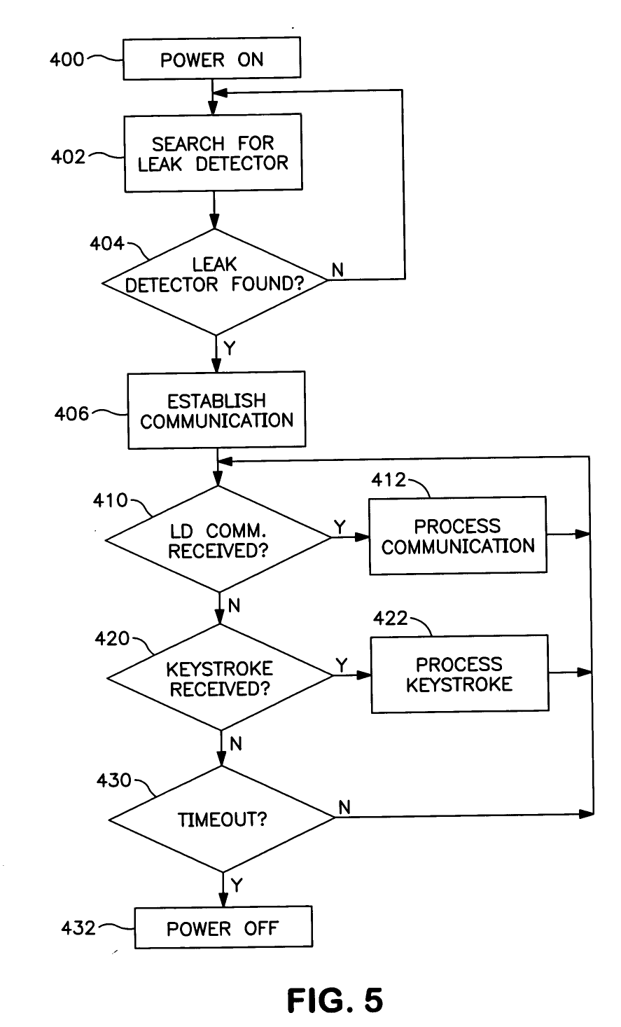

A flow chart that illustrates operation of the wireless remote unit in accordance with an embodiment of the invention is shown in FIG. 5. In step 400, power is turned on by operation of on/off key 210 (FIG. 3). In step 402, a search is performed for a leak detector within range of remote unit 30 and available for operation with remote unit 30. A signal is transmitted by RF transceiver 352 on a selected channel. The initial channel may be a default channel, for example. In step 404, a determination is made as to whether a leak detector has been found. If RF transceiver 352 does not receive a reply from a leak detector on the selected channel, the process returns to step 402 and a new channel is selected to continue the search for a leak detector. If a leak detector is found in step 404, communication may be established in step 406. The operator of remote unit 30 may confirm that the leak detector which replied is the leak detector of interest. If not, the operator can request that the search be continued in step 402. Assuming that communication is established with the leak detector in step 406, a timeout timer is started in step 406.

In step 410, controller 350 determines if a communication was received from the leak detector. If a leak detector communication is received via wireless link 330, antenna 202 and RF transceiver 352, the received data is processed by controller 350 in step 412. The received data is processed according to the type of data received. In the case of a measured leak rate signal, controller 350 may generate a display on display unit 32, may generate an audio signal that is sent to audio circuit 36, or both. In the case of a leak detector mode signal, controller 350 may generate a mode display on display unit 32. When a communication is received from the leak detector, the timeout timer is restarted and the process returns to step 410.

If a leak detector communication is not received, the controller 350 determines in step 420 if a keystroke has been received. If a keystroke is received, the keystroke is processed in step 422. The keystroke is processed according to the function of the selected key. Test/hold key 212, zero key 216 and standard leak key 218 cause the controller 350 to transmit signals to the leak detector via RF transceiver 352, antenna 202 and wireless link 330. Backlight key 214 causes the display backlight to toggle on and off. Setup keys 220 are processed according to the selected setup function. The keystroke also causes the timeout timer to be restarted, and the process returns to step 410.

If a keystroke is not received in step 420, controller 350 determines in step 430 if the timeout timer has elapsed. If the timeout timer is not elapsed, the process returns to step 410 and is available to receive leak detector communications and keystrokes. If the timeout timer has elapsed, power is turned off in step 432.

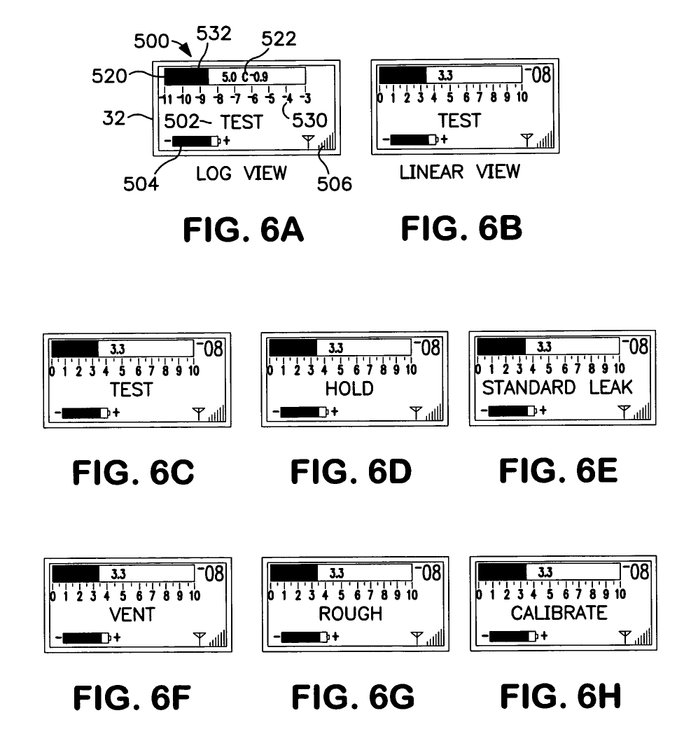

FIGS. 6A-6H illustrate examples of displays on display unit 32 of wireless remote unit 30 in accordance with embodiments of the invention. The display on display unit 32 may include a leak rate display 500, a mode display 502, a battery indicator 504 and a signal indicator 506. Battery indicator 504 may indicate the strength of battery 340 in remote unit 30, such as by the length of a darkened portion of a battery icon. Signal indicator 506 may use a conventional multiple bar display to indicate the relative strength of the signal received by RF transceiver 352.

In the embodiment of FIGS. 6A-6H, leak rate display 500 includes a bar graph display 520 and an alphanumeric display 522. The bar graph display 520 may include a scale 530 and a bar 532 having a length relative to scale 530 which indicates leak rate. In some embodiments, a log scale, shown in FIG. 6A, or a linear scale, shown in FIG. 6B, may be selected by the operator. The alphanumeric display 522 may utilize an exponential notation, since leak detector 10 is capable of measuring a wide range of leak rates. It will be understood that different leak rate displays may be utilized within the scope of the invention. For example, either the bar graph display 520 or the alphanumeric display 522 may be used alone. Further, other leak rate display techniques may be utilized.

The mode display 502 indicates the current operating mode of leak detector 10 using one or more words in the embodiment of FIGS. 6A-6H. Thus, the mode display 502 in FIGS. 6A-6C indicates that the leak detector is in “test” mode. Mode display 502 in FIG. 6D indicates the leak detector is in “hold” mode. Mode display 502 in FIG. 6E indicates the leak detector is in “standard leak” mode. Mode display 502 in FIG. 6F indicates the leak detector is in “vent” mode. Mode display 502 in FIG. 6G indicates the leak detector is in “rough” mode. Mode display 502 in FIG. 6H indicates the leak detector is in “calibrate” mode.

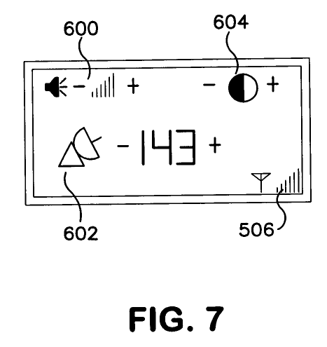

The displays shown in FIGS. 6A-6H and described above are used in the normal operating mode of the leak detection system. Remote unit 30 may also have one or more displays for setup functions of the remote unit. An example of a setup display is shown in FIG. 7. The setup display is selected by the enter key. Setup functions may include, but are not limited to, speaker volume control 600, display backlight brightness control, radio setup functions 602 including channel number adjustments, display screen contrast adjustment 604, and adjustment of time before the remote unit turns off after being inactive. It will be understood that different setup functions may be utilized within the scope of the invention.

It will be understood that remote unit 30 may have the capability of controlling some, all, or none of the operating modes of the leak detector. In the embodiment of FIG. 3, remote unit 30 may control the test, hold, zero and standard leak modes of the leak detector. In other embodiments, remote unit 30 may have more or less control of leak detector 10 and in some embodiments, remote unit 30 may have no control of the leak detector. In these embodiments, remote unit 30 serves as a monitor for display of measured leak rate and optionally may display other leak detector operating information, such as operating mode (describe set up functions).

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A leak detection system comprising:
a trace gas leak detector including a wireless base unit; and
a handheld wireless remote unit, which generates an alphanumeric display of leak rate measured by the leak detector, in response to leak detector information received by wireless link from the leak detector.

2. The leak detection system as defined in claim 1, wherein the wireless remote unit includes a wireless transceiver, which communicates with the wireless base unit of the leak detector, a display unit and a controller, responsive to the received leak detector information, to generate the display on the display unit.

3. The leak detection system as defined in claim 2, wherein the wireless remote unit further comprises a housing for the wireless transceiver, the display unit and the controller, the housing having a suitable size and shape for handheld operation.

4. The leak detection system as defined in claim 1, wherein the wireless remote unit is configured to display a leak detector operating mode.

5. The leak detection system as defined in claim 1, wherein the wireless remote unit further comprises a keypad to control operation of the leak detector by wireless link from the remote unit to the wireless base unit of the leak detector.

6. The leak detection system as defined in claim 5, wherein the keypad is configured to select an operating mode of the leak detector.

7. The leak detection system as defined in claim 2, wherein the controller is configured to generate on the display unit a bar graph display of leak rate measured by the leak detector.

8. The leak detection system as defined in claim 7, wherein the controller is configured for operator selection of a linear display or a log display of leak rate.

9. The leak detection system as defined in claim 2, wherein the controller is configured to generate an audio signal that is indicative of leak rate measured by the leak detector.

10. The leak detection system as defined in claim 1, wherein the transceiver comprises two or more channels to communicate with different leak detectors.

11. A wireless remote unit comprising:
a wireless transceiver configured for wireless communication with a base unit of a trace gas leak detector;
a display unit; and
a controller, responsive to leak detector information received by wireless link from the leak detector, to generate on the display unit an alphanumeric display of leak rate measured by the leak detector.

12. The wireless remote unit as defined in claim 11, wherein the controller is configured to generate on the display unit a display of leak detector operating mode.

13. The wireless remote unit as defined in claim 11, further comprising a keypad for entry of operator commands to control operation of the leak detector by wireless link from the remote unit to the leak detector.

14. The wireless remote unit as defined in claim 11, wherein the wireless transceiver includes two or more channels to communicate with different leak detectors.

15. The wireless remote unit as defined in claim 11, further comprising a housing for the wireless transceiver, the display unit and the controller, the housing having a size and shape for handheld operation.

16. The wireless remote unit as defined in claim 11, wherein the controller is configured to generate on the display unit a radio signal strength indicator.

17. A method for operating a trace gas leak detector, comprising:
measuring a leak rate of a unit under test with a trace gas leak detector;
transmitting information representing the measured leak rate to a wireless remote unit; and
providing an alphanumeric display of the measured leak rate on the wireless remote unit.

18. The method as defined in claim 17, further comprising displaying an operating mode of the leak detector on the wireless remote unit.

19. The method as defined in claim 17, further comprising controlling the leak detector from the wireless remote unit.

20. The method as defined in claim 19, wherein controlling the leak detector comprises controlling a leak detector operating mode.
